(19) United States
(12) Patent Application Publication
(10) Pub. No.: US 2026/0203884 A1
(43) Pub. Date: Jul. 16, 2026

(54) METHOD AND SYSTEM FOR ACCURATELY COUNTING ITEMS IN A STOREHOUSE

(71) Applicants: Wipro Limited, Bangalore (IN); Wipro Limited, East Brunswick, NJ (US)

(72) Inventor: Sarthak PANIGRAHI, Bangalore (IN)

(73) Assignees: Wipro Limited, Bangalore (IN); Wipro Limited, East Brunswick, NJ (US)

(21) Appl. No.: 19/134,887

(22) PCT Filed: Jun. 20, 2023
(86) PCT No.: PCT/US2023/068743

§ 371 Date: Jun. 2, 2025

(30) Foreign Application Priority Data
Jun. 17, 2022 (IN) 202241034928

(51) Int. Cl. G06T 7/00; G06K 7/14; G06Q 10/087; G06T 7/13; G06T 7/50; G06T 7/60; G06V 10/25; G06V 10/26; H04N 23/61; H04N 23/66; H04N 23/695

(52) U.S. Cl. CPC G06T 7/0002; G06K 7/1417; G06Q 10/08772; G06T 7/13; G06T 7/50; G06T 7/60; H04N 23/61; H04N 23/66; H04N 23/695; G06T 2207/30168; G06T 2207/30204; G06T 2207/30242; G06V 10/25; G06V 10/26

(57) ABSTRACT

The present disclosure describes method and apparatus for counting items in a storehouse. The method includes selecting one or more images from the plurality of images and pre-processing the selected images. The method includes processing the pre-processed images using a boundary detection model for determining bounding boxes of visible items present in the pre-processed images while removing partially visible items, side surfaces, and items of neighboring pallets present in the pre-processed images. The method further includes determining 3D coordinates of each bounding box and estimating height-depth levels of each visible item using the 3D coordinates to generate a 2D stacking pattern of each item layer. The method includes determining the item count by correlating the 2D stacking pattern of each layer with predefined stacking patterns. The present disclosure facilitates accurate counting of items even when rack arrangements are dynamic, items are stacked in non-uniform patterns, and under variable lighting conditions.

### TECHNICAL FIELD

The present disclosure generally relates to the technical field image processing and data analysis for inventory management in storehouses. Particularly, the present disclosure relates to a system and a method for accurately counting items in a storehouse using image processing and data analysis.

### BACKGROUND

Due to increasing customer demand for varied and novel products, industries are increasing their supply of items (e.g., goods/products). These goods/products must be stored in a designated storehouse or warehouses before being picked and shipped off to marketplace. This puts considerable stress on warehouse management activities to run flawlessly. Broadly warehouses management activities may include activities relating to inbound, outbound, and storage of items. In the storage stage, one such activity is inventory reconciliation or stocktaking activity, which basically keeps count of current inventory as per stock-keeping units (SKUs).

Stocktaking plays a crucial role in ensuring efficient supply chain operations within a warehouse. Stocktaking involves accurately counting and recording quantities of inventory present in the warehouse. Stocktaking is essential as it enables better utilization of space within the warehouse racks and helps minimize losses due to expired stock. In a typical warehouse, the items are usually arranged in pallets kept in multiple layers and pallets in turn are kept on racks in multiple layers horizontally and vertically. The tallying up of the items is usually carried out by workers employed in the warehouse, with a handheld digital (scanning) device or manually counting the items placed on the pallets. Such manual operations of inventory reconciliation are time consuming and resource intensive. Even with the use of handheld digital devices, the process is slow as the worker must physically locate the racks, find proper pallet, and then carry out scanning or counting task. Sometimes the warehouses may need to shut down their operation partially or fully until stocktaking operation is done. The stocktaking process may even require use of heavy machinery like forklifts/reach trucks to access shelves at higher levels.

To solve above problems, modern warehouses are adopting semi-automated and automated techniques of stocktaking. One such technique of automated stocktaking requires attaching of markers or tags (e.g., RFID tags) to the inbound items and removal of markers for the outbound items. In such marker-based solutions, the generation and printing of a huge number of markers needs to be done, which would consume a lot of (computing) resources, and extra manpower needs to be employed to diligently paste the specified category of markers on the carton of items. Some prior art solutions count stacked items at an inventory location using image analysis captured by cameras. However, these solutions give poor performance in low lighting conditions and when rack arrangement is dynamic (or where racks are to be rearranged or the items are to be changed for an inventory location within the warehouse). Other prior art techniques rely on prior information regarding placement of items in the pallets for counting the items. However, such techniques perform poorly in real-world situations where rack arrangements are dynamic and items are stacked in non-uniform stacking patterns. Additionally, counting of hidden items in a pallet is a challenging task (specifically, for the non-uniform stacking patterns). In general, a hidden item may refer to an item that is concealed or not readily visible or partially visible from frontside of a pallet when the pallet is inspected. When dealing with such pallets which include such hidden items (and non-uniform stacking patterns), careful inspection is required to ensure that all items are counted.

Thus, accurately counting warehouse items in real time is difficult using the conventional techniques (specifically, when rack arrangements are dynamic, items are stacked in non-uniform stacking patterns, and some pallet items are hidden and/or under variable lighting conditions). Hence, there exists a need for further improvements in the technology, especially for (time and resource) efficient techniques for identifying and keeping track of different items in warehouses.

The information disclosed in this background section is only for enhancement of understanding of the general background of the invention and should not be taken as an acknowledgement or any form of suggestion that this information forms the prior art already known to a person skilled in the art.

### SUMMARY

One or more shortcomings discussed above are overcome, and additional advantages are provided by the present disclosure. Additional features and advantages are realized through the techniques of the present disclosure. Other embodiments and aspects of the disclosure are described in detail herein and are considered a part of the disclosure.

In a non-limiting embodiment of the present disclosure, the present application discloses a method for counting items in a storehouse that includes a plurality of racks each including at least one pallet for storing one or more items. Each pallet is associated with a unique pallet identification marker and includes a plurality of layers of items arranged in one or more rows and columns. The method comprises receiving an input for counting items stored in one or more pallets of the plurality of racks, where the input includes at least one of location information and identification information of the one or more pallets. The method further includes enabling navigation of a remote imaging device based on the received input for capturing a plurality of images of each of the one or more pallets. For each of the one or more pallets, the method includes receiving, from the remote imaging device, a plurality of images of the pallet; selecting one or more images from the plurality of images and pre-processing the selected one or more images for accurately detecting one or more visible items present in the pre-processed images of the pallet; and processing the pre-processed images using a boundary detection model for determining bounding boxes of the one or more visible items present in the pre-processed images while removing partially visible items present in the pre-processed images, removing side surfaces of the one or more visible items, and removing items of neighboring pallets present in the pre-processed images. The method further includes determining real-world three dimensional (3D) geographical coordinates of each bounding box by taking the unique identification marker of the pallet as a reference point and estimating height and depth levels of each of the one or more visible items using the real-world 3D geographical coordinates to generate a 2D top-view stacking pattern of each layer of items present in the pallet. The method further includes determining a count of items present in the pallet by correlating the generated 2D top-view stacking pattern of each layer with one or more predefined stacking patterns.

In another non-limiting embodiment of the present disclosure, the present application discloses an apparatus for counting items in a storehouse that includes a plurality of racks each including at least one pallet for storing one or more items. Each pallet is associated with a unique pallet identification marker and includes a plurality of layers of items arranged in one or more rows and columns. The apparatus includes at least one memory and at least one processor communicatively coupled with the memory. The processor is configured to receive an input for counting items stored in one or more pallets of the plurality of racks, where the input includes at least one of location information and identification information of the one or more pallets and enable navigation of a remote imaging device based on the received input for capturing a plurality of images of each of the one or more pallets. For each of the one or more pallets, the processor is configured to receive, from the remote imaging device, a plurality of images of the pallet; select one or more images from the plurality of images and pre-processing the selected one or more images for accurately detecting one or more visible items present in the pre-processed images of the pallet; and process the pre-processed images using a boundary detection model for determining bounding boxes of the one or more visible items present in the pre-processed images while removing partially visible items present in the pre-processed images, removing side surfaces of the one or more visible items, and removing items of neighboring pallets present in the pre-processed images. The processor is further configured to determine real-world three dimensional (3D) geographical coordinates of each bounding box by taking the unique identification marker of the pallet as a reference point and estimate height and depth levels of each of the one or more visible items using the real-world 3D geographical coordinates to generate a 2D top-view stacking pattern of each layer of items present in the pallet. The processor is further configured to determine a count of items present in the pallet by correlating the generated 2D top-view stacking pattern of each layer with one or more predefined stacking patterns.

In another non-limiting embodiment of the present disclosure, the present application discloses a non-transitory computer readable media for counting items in a storehouse that includes a plurality of racks each including at least one pallet for storing one or more items, where each pallet is associated with a unique pallet identification marker and includes a plurality of layers of items arranged in one or more rows and columns. The non-transitory computer readable media stores one or more instructions which, when executed by at least one processor, cause the at least one processor to receive an input for counting items stored in one or more pallets of the plurality of racks, where the input includes at least one of location information and identification information of the one or more pallets; and enable navigation of a remote imaging device based on the received input for capturing a plurality of images of each of the one or more pallets. For each of the one or more pallets, the instructions further cause the processor to receive, from the remote imaging device, a plurality of images of the pallet, select one or more images from the plurality of images and pre-processing the selected one or more images for accurately detecting one or more visible items present in the pre-processed images of the pallet, and process the pre-processed images using a boundary detection model for determining bounding boxes of the one or more visible items present in the pre-processed images while removing partially visible items present in the pre-processed images, removing side surfaces of the one or more visible items, and removing items of neighboring pallets present in the pre-processed images. The instructions further cause the processor to determine real-world three dimensional (3D) geographical coordinates of each bounding box by taking the unique identification marker of the pallet as a reference point, estimate height and depth levels of each of the one or more visible items using the real-world 3D geographical coordinates to generate a 2D top-view stacking pattern of each layer of items present in the pallet, and determine a count of items present in the pallet by correlating the generated 2D top-view stacking pattern of each layer with one or more predefined stacking patterns.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Further aspects and advantages of the present disclosure will be readily understood from the following detailed description with reference to the accompanying drawings. Reference numerals have been used to refer to identical or functionally similar elements. The figures together with a detailed description below, are incorporated in and form part of the specification, and serve to further illustrate the embodiments and explain various principles and advantages, in accordance with the present disclosure wherein:

FIG. 1 illustrates an exemplary environment 100 in which the techniques consistent with the present disclosure may be implemented, in accordance with some embodiments of the present disclosure.

FIG. 2 shows an exemplary illustration 200 where a plurality of items are placed on a pallet.

FIG. 3 shows a detailed block diagram 300 of the exemplary warehouse environment 100 of FIG. 1, in accordance with some embodiments of the present disclosure.

FIG. 4 shows a flowchart 400 illustrating a method for accurately counting items in a storehouse, in accordance with some embodiments of the present disclosure.

FIG. 5(a) shows an exemplary camera image 500-1 of a shelf/pallet, in accordance with some embodiments of the present disclosure.

FIG. 5(b) shows an exemplary line image 500-2 corresponding to the camera image 500-1 of FIG. 5(a), in accordance with some embodiments of the present disclosure.

FIG. 6(a) shows as exemplary pre-processed camera image 600-1 of a pallet, in accordance with some embodiments of the present disclosure.

FIG. 6(b) shows an exemplary line image 600-2 corresponding to the pre-processed camera image 600-1 of FIG. 6(a), in accordance with some embodiments of the present disclosure.

FIG. 7(a) shows an exemplary processed camera image 700-1 showing bounding boxes of the one or more visible items, in accordance with some embodiments of the present disclosure.

FIG. 7(b) shows an exemplary line image 700-2 corresponding to the processed camera image 700-1 of FIG. 7(a), in accordance with some embodiments of the present disclosure.

FIG. 8(a) to 8(c) show different reference stacking patterns 800-1, 800-2, and 800-3 for different layers of items placed on a pallet, in accordance with some embodiments of the present disclosure.

FIG. 9(a) to 9(c) show comparison results 900-1, 900-2, and 900-3 of different stacking patterns for different layers of items placed on a pallet, in accordance with some embodiments of the present disclosure.

FIG. 10 shows an exemplary image 1000 showing count of items placed on a pallet, in accordance with some embodiments of the present disclosure.

FIG. 11 shows a high-level block diagram of an apparatus 1100 where the techniques consistent with the present disclosure may be implemented.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present disclosure described herein as “exemplary” is not necessarily to be construed as preferred or advantageous over other embodiments. While the disclosure is susceptible to various modifications and alternative forms, specific embodiments thereof have been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

The terms like “at least one” and “one or more” may be used interchangeably throughout the description. The terms like “a plurality of” and “multiple” may be used interchangeably throughout the description. Further, the terms like “object”, “item”, and “box” may be used interchangeably throughout the description. Further, the terms like “pallet marker”, “pallet identification marker”, and “unique pallet identification marker” may be used interchangeably throughout the description.

As described in background section, accurately counting warehouse items in real time is difficult using the conventional techniques (specifically, when rack arrangements are dynamic, items are stacked in non-uniform stacking patterns, and/or under variable lighting conditions). In most of the warehouses, rack arrangements are dynamically altered thus making it difficult for an imaging device to correct its 3-dimensional (3D) position and orientation depending on changed rack arrangements. This may lead to inaccurate capturing of target pallet view and items in pallets, resulting in inaccurate counting of items. Also, preplanning of such positioning of imaging device is not feasible. For pallets with multiple depth layers of stacked items, counting of hidden items is a problem. Conventional mechanisms fail to identify the hidden items across multiple depth layers of items in a pallet, thereby leading to incorrect item counting. Specifically, counting of hidden items is a challenge when stacking patterns are non-uniform. There are no fully autonomous technique specifically designed for detecting and accurately counting the hidden items (arranged in non-uniform stacking pattern) on a pallet. Conventional edge detection in scenarios involving the hidden items on the pallet, may fail to detect an item as a hidden item due to occlusion or overlapping of that hidden item with respect to other remaining items on the pallet. This occlusion or overlapping can obstruct the edges and make them indistinguishable, resulting in failure to detect the hidden items. Hence, accounting for hidden items in non-uniform stacking patterns is challenging and often not included in the conventional item counting method. As used herein, a hidden item of a pallet may refer to an item that is concealed or not readily visible or partially visible from frontside of the pallet when the pallet is inspected. Stacking pattern may be predefined based on the strategic placement of items (i.e., the items may intentionally be placed in a way to save space), that is why even after removal of items from the frontside of the pallet, certain items at the back layers may not be fully visible. When dealing with pallets having such hidden items, careful inspection is required to ensure that all items are counted.

Sometimes, the warehouses might not have proper lighting conditions and hence, existing RGB based marker detection mechanism may fail to work under low light conditions. Because the conventional imaging devices fail to detect box edges from RGB images under the variable light conditions, which results in incorrect stocktaking of the items as few items may be missed in case of low light conditions. Further, conventional imaging based solutions have a fixed Field of View (FOV) and hence, multiple cameras setups at different locations are required to capture accurate FOV of a pallet. As discussed earlier, in external marker-based solutions, generation and printing of a huge number of markers needs to be performed and extra effort needs to be employed to diligently paste specified category of markers on the cartons of items. It is difficult to rely on the markers for counting items because in case a marker gets missed during transport of an item, there are high chances of the item being left out in counting process and it may lead to inaccurate count of items.

To overcome the above-mentioned and other related problems, the present disclosure proposes techniques for accurately and autonomously counting items (which may be placed non-uniformly) without placing any external markers on the items in the warehouse environment. The techniques of the present disclosure efficiently count the items even where rack arrangements are dynamic, item arrangements are non-uniform, and items are placed under variable light conditions (e.g., under low light).

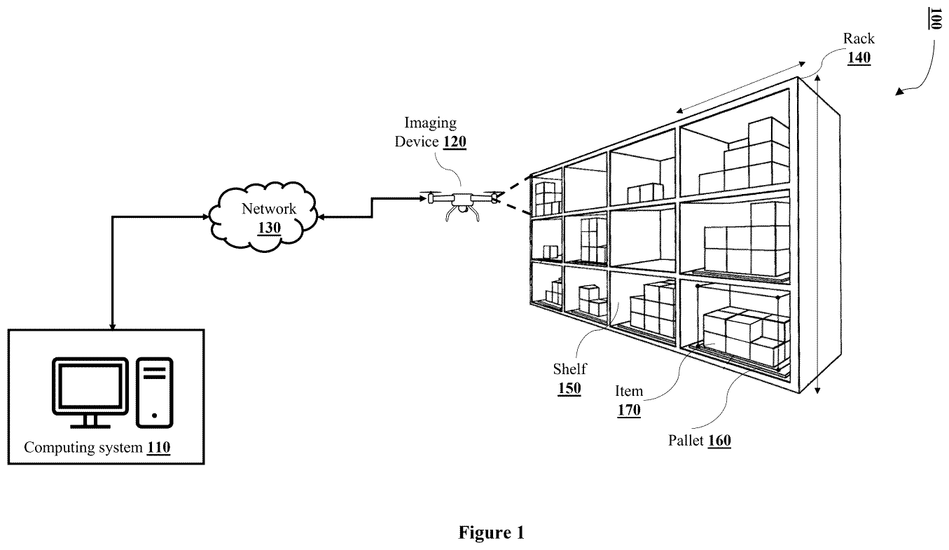

Referring now to FIG. 1, which illustrates an exemplary environment or warehouse 100 in which the techniques consistent with the present disclosure may be implemented, in accordance with some embodiments of the present disclosure. The exemplary environment 100 may be a warehouse (also referred to as “storehouse”) for storing goods, products, objects in cartons or boxes (a box may be referred to as an “item in the present disclosure”). The warehouse environment 100 may comprise a computing system 100 (also referred to as “item counting system”) in communication with an imaging device 120 via a network 130.

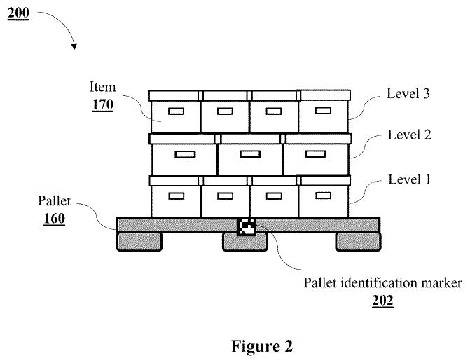

The warehouse environment 100 may comprise a plurality of racks 140 for placing a plurality of items. A rack may be referred to as a collection of shelves arranged vertically or horizontally. For instance, FIG. 1 illustrates four racks 140, where each rack includes three shelves 150 arranged/connected vertically. However, the present disclosure is not limited thereto. Each shelf 150 of a rack may be configured to store a plurality of items 170. The plurality of items may include groceries, medicines, food products, apparels, toys, and the like. In one embodiment, each of the plurality of items may be stored inside a box or a container and stored in the shelves 150. In another embodiment, the plurality of items may be stored on a pallet 160 in one or more levels of stacking, as shown in FIG. 2.

FIG. 2 shows an exemplary illustration 200 where a plurality of items 170 are placed on an exemplary pallet 160. The plurality of items 170 stacked vertically one above the other and horizontally one behind the other. The plurality of items 170 may be stored or arranged in different patterns at each level. The pattern in which the plurality of items are stacked may be referred to as a “stacking pattern”. The stacking pattern indicates one or more possibilities to store or arrange the one or more items or boxes 170 at each level on the pallet 160. In an embodiment, each level may have a stacking pattern (which may be an uniform stacking pattern or a non-uniform stacking pattern). For example, the uniform stacking pattern may include a horizontal stacking pattern, a vertical stacking pattern, and a combination thereof. The non-uniform stacking pattern is indicative of a pattern where the items are arranged in irregular-fashion/non-linear pattern other than a regular horizontal pattern, a regular vertical pattern, or a combination thereof. Example non-uniform pattern of hidden items may include: interlocking or Tetris-style stacking, overhang alignment, and the like. Used herein, (i) interlocking or tetris-style stacking means: the items that can be stacked in a way that they interlock with each other, similar to how puzzle pieces fit together. This technique helps minimize gaps and creates a more stable and compact arrangement, thus saving space; and (ii) the overhang alignment pattern means: when items are stacked on a pallet, they can be aligned in a way that allows a slight overhang of the items on the edges of the pallet. This technique optimizes the use of the pallet's surface area, making it possible to fit more items within the given space. A unique Stock Keeping Unit (SKU) marker 202 (also referred to as “unique pallet identification marker”) may be associated with each pallet 160 in the warehouse 100. For example, the SKU marker 202 may include an ARuCo marker, a bar code, a Quick Response (QR) code, a user-defined pattern, and the like. The SKU marker 202 may be fixed or pasted at a predefined location (e.g., at the center) on the pallet 160.

Referring back to FIG. 2, the imaging device 120 may be a remote imaging device 120 and may include one or more image capturing units or cameras. In one embodiment, the imaging device 120 may be a remotely controlled drone equipped with one or more cameras. The imaging device 120 may be configured to capture images of items 170 stored on the pallets 160 upon receiving instructions from the computing system 110. The captured images may be provided to the computing system 110 for counting items using the captured images. The computing system 110 may be implemented as a standalone server, a remote server, a desktop computer, a laptop, a smartphone, and a combination thereof. The computing system 110 and the imaging device 120 may be communicatively connected using at least one wired and/or wireless interface via the communication network 130.

The network 130 may comprise Bluetooth, Internet, Local Area Network (LAN), Wide Area Network (WAN), Metropolitan Area Network (MAN), etc. In certain embodiments, the network 130 may include a wireless network, such as, but not restricted to, a cellular network and may employ various technologies including Enhanced Data rates for Global Evolution (EDGE), General Packet Radio Service (GPRS), Global System for Mobile Communications (GSM), Internet protocol Multimedia Subsystem (IMS), Universal Mobile Telecommunications System (UMTS) etc. In one embodiment, the network 130 may include or otherwise cover networks or subnetworks, each of which may include, for example, a wired or wireless data pathway.

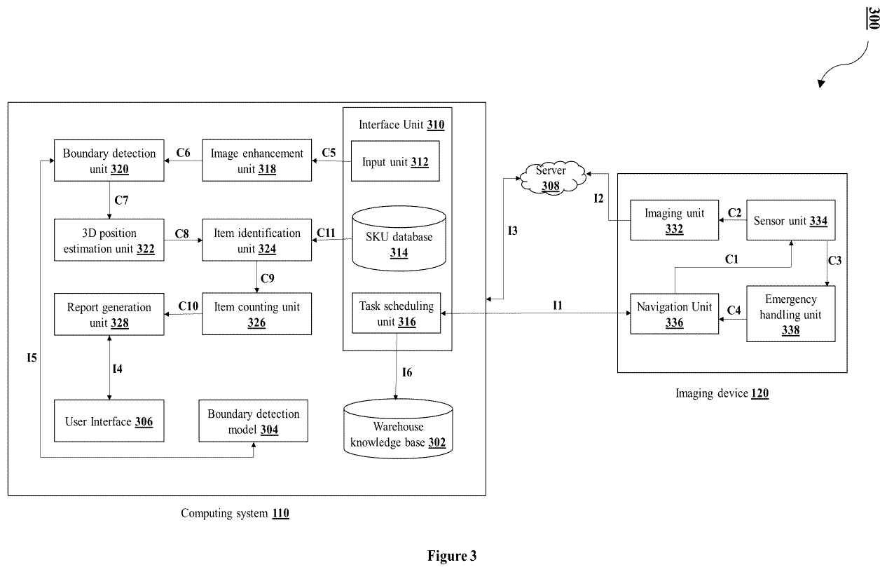

Now, FIG. 1 is explained in conjunction with FIG. 3, which is a detailed block diagram 300 of the exemplary warehouse environment 100, in accordance with some embodiments of the present disclosure. According to an embodiment of the present disclosure, the environment 100, 300 may comprise the computing system 110 communicatively coupled with the imaging device 120 via the network 130. Each of the computing system 110 and the imaging device 120 may include one or more modules/means/units, as shown in FIG. 3. For instance, the computing system 110 may include an interface unit 310 which may include an input unit 312, a SKU database 314, and a task scheduling unit 316. The computing system 110 may further include various units such as an image enhancement unit 318, a boundary detection unit 320, a 3D position estimation unit 322, an item identification unit 324, an item counting unit 326, a report generation unit 328. The computing system 110 may further include a warehouse knowledge database (KB) 302, a boundary detection module 304, and a user interface (UI) 306. Similarly, the imaging device 120 may include an imaging unit 332, a sensor unit 334, a navigation unit 336, and an emergency handling unit 338.

The one or more units or modules may be interconnected with each other via one or more interfaces and/or connectors I1 to I6 and C1 to C11, as shown in FIG. 3. The interfaces/connectors may include a variety of software and hardware interfaces, for example, a web interface, a graphical user interface, an input device-output device (I/O) interface, a network interface, and the like. The I/O interfaces may allow two units/entities to communicate with each other and with other input/output entities directly or through other devices. The network interface may allow two entities to interact with one or more networks either directly or via any other network. The interfaces/connectors may facilitate communication based on WLAN protocols, Application Programming Interface (API) calls, Bluetooth, Remote Procedure Calls (RPC), and like. Detailed description of various units/modules of FIG. 3 and the interfaces/connectors is illustrated in forthcoming paragraphs.

In one non-limiting embodiment, the imaging device 120 may be mounted on or may include an Unmanned aerial Vehicle (UAV), an Autonomous Mobile Robot (AMR), an Autonomous Guided Vehicle (AGV), or any similar mobile robot systems with similar functionality. The imaging device 120 may be responsible for traversing passages/aisles in the warehouse to collect live input images regarding current state of number of items present in different pallets throughout the warehouse. In an embodiment, the imaging device 120 can be any commercial off the shelf drone or can be a custom developed drone.

In one non-limiting embodiment, the imaging unit 332 may be integrated to an onboard computing unit and receive a signal to capture digital images of an area in its Field of View (FOV). The imaging unit 332 may capture live data of pallet identification markers and other warehouse objects while checking for obstacles. The imaging unit 332 may include image sensors including, but not limited to, stereo depth cameras (Real sense), 2D Lidar imaging unit, digital color camera unit, barcode scanner, Raspberry Pi (RPi) camera, RGB cameras, depth cameras, and the like. The imaging unit 332 is responsible for collection of real time input data (i.e., images/videos) in the warehouse. The imaging unit 332 may be connected with the file server 308 via the interface I2 for sending the captured images in an organized manner with respect to assigned task.

In one non-limiting embodiment, the navigation unit 336 of the imaging device 120 may be configured to initiate navigation of the imaging device 120 from a source location to at lest one destination location. For example, in case of drone, flight navigation unit is configured for initiating the drone from takeoff to landing the drone in a landing zone abiding various navigation protocols. The navigation unit 336 may include onboard processing capabilities and use a navigation path devised by the computing system 110 and manage the navigation by constantly communicating with a Navigation Control Unit (NCU). The navigation unit 336 may be responsible for indoor obstacle avoidance and for position and orientation correction of the NCU in the robot with respect to the pallets. In an embodiment, the NCU refers to a Flight Control Unit (FCU). The navigation unit 336 may send necessary navigation related information to the sensor control unit 334 via the interface C1.

In one non-limiting embodiment, the sensor control unit 334 may includes entire sensor suite including but not limited to Power Monitor and Voltage Regulator, Autopilot (like Pixhawk4) with Inertial Measurement Unit (IMU), LIDAR, Optical Flow sensor, Radio Control Receiver, Wi-Fi module, RPi camera, a propulsion unit, and like. The sensor control unit 334 may be responsible for working and integration of the NCU which manages movement of imaging device 120 by coordinating with the propulsion unit. The sensor control unit 334 may send a signal to the imaging unit 332 via the interface C2 when the imaging device 120 is stable and in correct orientation for capturing images. The sensor control unit 334 may also send live sensor feed data to the emergency handling unit 338 for troubleshooting and monitoring health of the imaging device 120.

In one non-limiting embodiment, when any anomaly is detected during the navigation, the imaging device 120 may come across any unforeseen circumstance which may be precarious for the imaging device 120 or the warehouse environment 100. In such scenarios, the emergency handling unit 338 enforces some particular action to ensure safety of the imaging device 120 considering surrounding environment which may include immediately landing the imaging device 120 in its current position, backtracking the imaging device 120 to last safe position, and the like. The emergency handling unit 338 communicates with the NCU to pass instructions for failure handling. In one non-limiting embodiment, the imaging device 120 may include external lightning source pointing towards frontside on the pallets (in the direction of camera). This improves the accuracy for detection of SKU items and SKU type in bad lightning conditions. The imaging device 120 may include event-based vision sensors to facilitate quick obstacle avoidance.

In one non-limiting embodiment, the warehouse Knowledge Base (KB) 302 may include information related to a particular warehouse. The information may include one or more parameters related to racks, pallets, items, etc. Specifically, the warehouse KB 302 may include geographical location information of each rack, dimensions (length, breadth, and height) of each rack, geographical location information of each pallet and/or shelf, dimensions (length, breadth, and height) of each pallet and/or shelf, identification information of each pallet and/or shelf, a maximum number of items stored in each pallet, a type of items stored in each pallet (e.g., SKU-ID), predefined stacking patterns associated with each type of items, and other related parameters such as aisle width, and the like. The warehouse KB 302 may be connected with the interface unit 304 over the interface “I6” and may store and/or convey required data of the warehouse to the interface unit 304 for tasks like planning path for navigation of the remote imaging unit 120.

In one non-limiting embodiment, the boundary detection model 304 may be a machine learning (specifically, deep learning) based model which may use Faster RCNN object detection framework to detect boxes or the SKU items from images captured by the imaging device 120. The boundary detection unit leverages the boundary detection model 304 for accurately predicting periphery of the frontal faces of visible items. The boundary detection model 304 may receive user feedback from a report generation unit to periodically update weight files so as to provide accurate results. In one non-limiting embodiment, the user interface (UI) 306 may facilitate interaction of the end-user with the computing system 110 for tasks like viewing reports, assigning an item counting task, and the like.

In one non-limiting embodiment, the file server 308 may be a cloud based or a physical server which may be configured to buffer the data communicated between the computing system 110 and the imaging device 120. Specifically, the file server 308 may receive the raw images captured by the imaging device 120 via the interface I2 and store the received images in an organized manner with respect to a scheduled task. The server 308 may transmit the captured images as-is to the computing system 110 via the interface I3. The interface I3 may be used to write data in the file server 308 based on user requirements such as report submission or anomalies in captured data. In one non-limiting embodiment, the file server 308 may perform some pre-processing on the images received from the imaging device 120 and then transmit the pre-processed images to the computing system 110.

In one non-limiting embodiment, the interface unit 310 may act as an interface or as an orchestrator for the imaging device 120 and other agents in the warehouse 100. The interface unit 310 may connect to the image device 120 via interfaces I1, I2, I3 to relay necessary data for navigation and may receive inputs from a user as well. The interface unit 310 may include the input unit 312, the SKU database 314, and the task scheduling unit 316. The task scheduling unit 316 may be configured to create a task based on user inputs and assign the task to the imaging device 120 via the interface I1. For instance, a warehouse manager based upon his discretion, may select a SKU item and its rack identity (or rack location information) using the user interface 306. The warehouse manager can also select multiple SKU items to be counted and give their required location information similarly. Every task for single or multiple SKU items may be assigned a task id. Once task details are received by the computing system 110, the task scheduling unit 316 may receive necessary information from the warehouse KB 302 to create the task. In one non-limiting embodiment, the task scheduling unit 316 may be configured to create and maintain a digital twin of the warehouse to aid with planning path of the imaging device 120 based upon the task details.

The input unit 312 may collect information about pallet images captured by the imaging device 120. The input unit 312 may retrieve raw images (captured by the imaging device 120) from the remote file server 308 with respect to every task identifier and pre-process the raw images and selects one or more useful images. In another embodiment, when the file server 308 selects one or more useful images from the raw images, the input unit 312 may retrieve one or more selected images from the remote file server 308 with respect to every task identifier. In an embodiment, the input unit 312 may be a part of the imaging device 120 and performs pre-processing on the captured images and transmit pre-processed images to the file server 308. The SKU database 314 may be maintained for all different types of SKU items stored in the warehouse along with their information such as name, unique identification, dimensions (length, breadth, height, and like), possible stacking patterns, dimensions of different stacking patterns, etc. In FIG. 1, the warehouse KB 302 and SKU database 314 are shown as separate databases. However, the present disclosure is not limited thereto and in one non-limiting embodiment, the warehouse KB 302 and the SKU database 314 may be part of same database/memory.

As discussed above, the computing system 110 may include various units like the image enhancement unit 318, the boundary detection unit 320, the 3D position estimation unit 322, the item identification unit 324, the item counting unit 326, and the report generation unit 328. The image enhancement unit 318 may be communicatively coupled with the input unit 312 for receiving one or more selected images via the interface C5. The image enhancement unit 318 may extract a region of interest by masking unwanted portions from each of the selected one or more images while taking the unique pallet identification marker present in the selected images and/or shelf dimensions as a reference point. The image enhancement unit 318 may further performing gamma correction on each of the masked one or more images for enhancing image brightness. This unit returns a brightened image depending on set parameter. The image enhancement unit 318 may sharpen or dilate other frames of the selected images to increase the accuracy. The image enhancement unit 318 may convey the enhanced set of images to the boundary detection unit 320 via interface C6.

The boundary detection unit 320 leverages the boundary detection model 304 for accurately predicting boundaries of frontal faces of visible SKU items in a pallet image and returns bounding box coordinates for the visible SKU items. Specifically, the boundary detection unit 320 may include a SKU detection unit and a false positive detection unit. The SKU detection unit may be configured to detect boundaries or edges of the visible SKU items in the pallet image using a combination of both RGB and depth image inputs. The false positive detection may be configured to filter false positives from the detections performed by the SKU detection unit. Based on a set of rules, a set of images may be selected which have detections of fully visible boxes in an area of the pallet and other detections may be removed based on the set of rules. In one example, the boundary detection unit 320 may annotate (i) bounding box coordinates (item corners); and (ii) a count of SKU items; on the visible faces of fully visible SKU items detected in input images so as to obtain a count of fully visible front faces. The boundary detection unit 320 may send bounding box coordinate data and a count of number of detections to the 3D position estimation unit 322 via the interface C7.

In one non-limiting embodiment, the 3D position estimation unit 322 may be configured to return the real-world 3D position (or geographical coordinates) of each visible SKU item (or for each bounding box) by taking the unique identification marker of the pallet as a reference point. The 3D position estimation unit 322 may return 3D position coordinates of each SKU item written in center top area of the SKU item after correlating the RGB frame(s) with the depth frame(s). The 3D position estimation unit 322 may send the 3D position data and pallet identification marker to the item identification unit 324 via the interface C8.

In one non-limiting embodiment, the item identification unit 324 may be configured to detect the type of SKU items stored in the pallet (i.e., SKU identifier or SKU-ID). The item identification unit 324 communicates with the SKU database 314 via the interface C11 and correlates the received pallet identification marker to return the SKU-ID and related information. It may be noted that the interface C11 is used to communicate metadata (regarding mapping of pallet identification marker with SKU-ID) from the SKU database 314 to the item identification unit 324. The item identification unit 324 may send 3D position data and the SKU-ID data to the item counting unit 326 via the interface C9.

In one non-limiting embodiment, the item counting unit 326 may be configured to count the number of items in the pallet. The item counting unit 326 may include a height and depth estimation unit, a pattern identification unit, a missing item identification unit, and an item count generation unit. The height and depth estimation unit may cluster the detected items into different height levels seen in the pallet and retrieve respective depth levels from transformed depth image. The height and depth estimation unit may generate 2D top-view stacking patterns of each layer present in the pallet. Based on the dimensions of the items and the 3D position data, the pattern identification unit may match the generated 2D top-view stacking patterns to their respective arrangement patterns. Based on the identified arrangement patterns, the missing item identification unit may identify missing items for each layer in the pallet (in case of the pallet is not full) by comparing the 3D locations of each visible item with 3D location in the reference stacking patterns. Finally, the item count generation unit may determine a total count of the items present in the pallet by subtracting missing box count from the maximum count of boxes which can be stored in the pallet. The item counting unit 326 may send the total count of items and other details to the report generation unit 328 via the interface C10.

In one non-limiting embodiment, the report generation unit 328 may be configured to generate a final report for a particular task ID and send the data to the end user for displaying in a tabular format along with images of the pallet. In one non-limiting embodiment, the report generation unit 328 may be embedded with a feedback functionality to improve the detection of SKU items by sending feedback information to the boundary detection model 304.

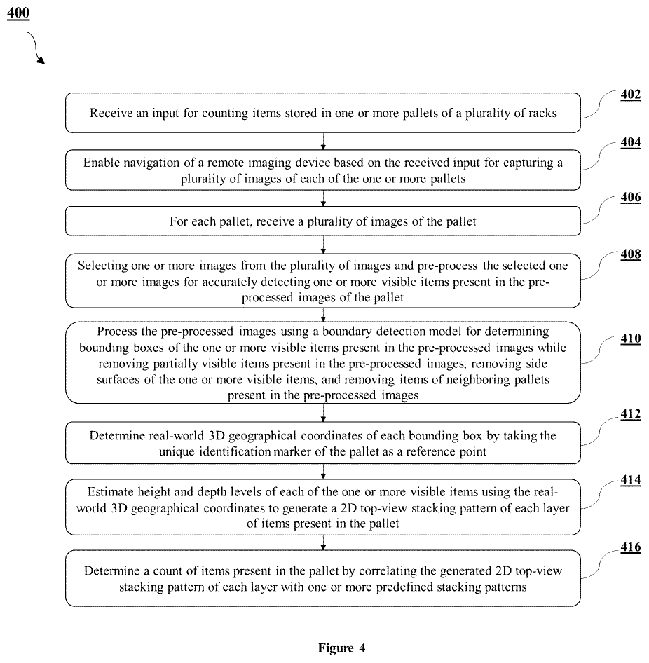

Referring now to FIG. 4 which describe a flow chart of a method 400 which is followed for improved stocktaking and counting items without using external markers in a storehouse 100 that includes a plurality of racks 140 each comprising at least one pallet 160 for storing one or more items 170. Each pallet may be associated with a unique pallet identification marker 202 and includes a plurality of layers or levels of items arranged in one or more rows and columns.

Initially, the computing system 110 may generate or update one or more databases associated with the warehouse. Specifically, the computing system 110 may acquire warehouse details and SKU item details to populate or generate the warehouse KB 302 and the SKU database 314 with the respective relevant data. The computing system 110 may acquire 3D geometrical stacking patterns of different types of SKU items and converts them into a format that can be used by the task scheduling unit 316 and the item counting unit 326. Such converted patterns may then be stored in the SKU database 314. For each type of SKU item, the computing system 110 captures information related to name of the SKU item, dimensions of the SKU item, the maximum height levels of a stack of the SKU item, the maximum length and depth of the stack of SKU items, different stacking patterns for successive odd and even height levels of the SKU item, and like. The computing system also assigns a unique identify (SKU-ID) to each type of SKU item and stores the captured information for each SKU item in the SKU database 314 in association with the corresponding SKU-ID. By storing the SKU information in separate database, the memory requirement in the warehouse KB 302 may be reduced. As discussed earlier, the warehouse KB 302 stores information related to different pallets such as identification information of a pallet, a type of SKU items (e.g., SKU-ID) stored in the pallet, and like. Thus, if identification information of a pallet is known, the information related to SKU items stored in that pallet can be easily fetched from the SKU database 314 by using the SKU-ID as a key (which is a common field in both warehouse KB 302 and the SKU database 314).

At block 402 of the method 400, the computing system 110 may receive an input for counting items stored in one or more pallets 160 of the plurality of racks 140. The input may include at least one of location information and identification information (e.g., pallet identification marker) of the one or more pallets 160. For instance, out of the numerous SKU items stored in the warehouse, an end user (e.g., a warehouse manager) may need to count number of SKU items available at the current time. The warehouse manager may select a SKU item and its pallet/rack identity and/or pallet/rack location information on the user interface 306 to interact with the computing system 110. The warehouse manager can also select multiple SKU items to be counted and provide their required information similarly. All this information is handled by the task scheduling unit 316. This scenario where instances of single or multiple SKU items need to be counted is termed as a task and an identity (task-ID) is assigned to such task.

At block 404 of the method 400, upon receiving the input for counting items, the computing system 110 performs path planning for the imaging device 120 with the help of digital twin and the warehouse KB 302 which includes the warehouse mapping. Specifically, at block 404, the computing system 110 enables navigation of the imaging device 120 or instructs the imaging device 120 (e.g., via interface I1) to navigate to the specified location based on the received input for capturing a plurality of images of each of the one or more pallets 160. The navigation unit 336 of the imaging device 120 receives the task data including task-id, path planning data, and the location and/or identification of the one or more pallets 160. The imaging device 120 is initiated from its home position and navigates towards the respective pallets based on the path planning.

The imaging device 120 navigates to a first pallet and positions itself taking the pallet identification marker as a reference point until the full FOV of the pallet is visible. It may be noted that the pallet identification marker 202 (which may be ArUco marker) is pasted at midpoint of a pallet beam which is also geometrically the center of stack of items, as shown in FIG. 2. The aim is to align the imaging unit 332 of the imaging device 120 at a fixed distance away from the pallet identification marker 202 so that the imaging device 120 gets full FOV for a maximum possible height of the items in the pallet. The position of the imaging unit 332 with respect to the marker and the pallet of items may be determined based on camera characteristics like FOV and depth range.

During the navigation process controlled by the navigation unit 336, there is a scenario where the pallet marker 202 comes within the field of view (FOV) of the imaging unit 332. In this situation, the imaging device 120 is utilized to capture images or video of the pallet marker 202. Using predefined library functions specifically designed for this purpose, the imaging unit 332 analyses the captured imagery to extract relevant information, such as current translational vector. The current translational vector represents the direction and distance from the imaging unit 332 to the pallet marker 202. This extracted translational vector is significant as it provides crucial spatial information required for positioning the imaging device 120. The translational vector is transformed into a frame of reference of the Flight Control Unit (FCU), which acts as a central control system for the remote imaging device 120. Once the translational vector is transformed into the FCU's frame of reference, it can be utilized to generate commands for the sensor control unit 334, which is responsible for managing movements and positioning of the imaging device 120. The commands derived from the transformed translational vector instruct the sensor control unit 334 to adjust position of the imaging device 120.

When the imaging unit 332 of the imaging unit 120 acquires 6D pose information and translation position, the imaging device 120 ensures that imaging unit's or camera's roll, pitch, and yaw are set to 0 degrees relative to the pallet marker 202. This alignment enables the camera to capture an orthographic image projection on its plane. For instance, during navigation of the imaging device 120, there may be a need to adjust the yaw angle once goal position is reached. As the imaging device 120 approaches vicinity of the goal position, the pallet marker comes into the FOV of the imaging device 120. At this point, a translational vector and the yaw angle, derived from the rotational vector, are obtained. However, the positional values (x and y) provided by the library function in this camera orientation are not the actual displacement values to be applied to the imaging device 120 after the yaw correction. This is specifically when the imaging unit 120 is parallel to the marker plane. Thus, both rotational and translational correction from a single image frame on the flight are performed for optimization of time duration of flight and movements of the imaging device 120. The rotational and translational correction are performed such that the camera is orthogonal to the pallet marker 202 for capturing orthographic images of the pallet. In non-limiting embodiment, the computing system 110 may be configured to communicate with the imaging device 120 to align the position of the imaging device 120. In such embodiment, the imaging device 120 may capture and send one or more images to the computing system 110. The computing system 110 may analyze the received images and accordingly provide necessary instructions to the imaging device 120 for properly aligning the imaging device 120.

Once the imaging device 120 is aligned at a fixed distance away from the pallet identification marker for capturing full FOV orthographic images of the pallet, the imaging device 120 captures a plurality of different images (e.g., RGB images, depth images, and the like) of the pallet and then navigates to the next pallet that is scheduled in the task data. In this manner, the imaging device 120 captured a plurality of images of different types for each pallet and transmits the captured images to the file server 308 via the interface I2. It may be noted that the RGB image is a color image frame and the depth image is obtained by stereo vision or other mechanism like LiDAR.

At block 406 of the method 400, the computing system 110 may receive the plurality of images of different types for each pallet captured by the imaging device 120.

At block 408 of the method 400, for each specific pallet, the computing system 110 then selects one or more good images from the plurality of images that includes RGB and depth images or image frames. Initially, a blur detection unit (part of the image enhancement unit 318) may filter out non-blurred images from the plurality of images based on the sharpness of image edges. Specifically, the image enhancement unit 318 checks if there is very low variance in an image (i.e., there is a tiny spread of responses indicating there are very little edges in the image implying the image is blurry).

Once the non-blurred images are filtered out, the computing system 110 may select one or more images from the non-blurred images of the specific pallet which satisfy one or more criteria. For instance, the computing system 110 may check for presence of pallet marker in the non-blurred images and select those images which include pallet marker. Further, the computing system 110 may check whether a full FOV is captured or not as per the shelf and pallet dimensions specified in the warehouse KB 302, and select those images which have full FOV of the pallet. This is important as the item counting unit 326 cannot miss any data points from the input images in the pallet and it also cannot use data from other items placed in the neighboring pallets. Further, the computing system 110 may check for images having bad/unreadable depth frames due to any unforeseen hardware issues or other reasons, and selects images includes non-noisy or readable frames. Used herein, non-noisy or readable frames may include image frames with noise level or blurring level below a predetermined level. The predetermined level may be an indicative of a noise level in an image that introduces false edges or obscure real edges during the edge detection, making it challenging to detect the hidden items accurately. Specifically, the computing system 110 may check whether there is any significant noise associated within the region of items of the specific pallet, which might affect obtaining depth values. The computing system 110 checks whether entire depth frame has issues due to noise resulting in unreadable depth values. The one or more (non-blurred) images of the specific pallet which satisfy some or all of the above criteria are selected for further processing.

At block 408, the computing system 110 may perform pre-processing on the selected one or more images of the specific pallet for accurately detecting one or more visible items present in the pre-processed images. In one non-limiting embodiment, pre-processing a selected image may include extracting region of interest from the selected image (which is full pallet view with the pallet marker) by masking out the unwanted/unnecessary regions or portions from the selected image such as pallet markers of adjacent pallet which might come in the field of view and which may potentially cause conflict with the item counting process. The masking of the unwanted/unnecessary regions or portions from the selected image is based on specific pallet dimensions, maximum height of item stack, pallet marker dimensions, and pixel scaling factor. In this embodiment, the pallet marker is used as the center point of reference for masking out the unwanted portions. In masking, the regions outside the pallet area are replaced with a white background so that the selected image retains its resolution. The computing system 110 is configured to count a single pallet for a specific time instance by selecting a specific region of interest based on the pallet marker present in the task data.

In one non-limiting embodiment, the operation of pre-processing a selected image may further include performing gamma correction on the selected images for enhancing image brightness. For instance, the image enhancement unit 318 may be configured to increase the brightness of the selected image with gamma correction as the gamma correction improves accuracy of detection and provides better results.

In one non-limiting embodiment, the operation of pre-processing a selected image may include processing the selected images to decode pallet information present in the pallet identification mark. For instance, the computing system 110 may decode the decode pallet information and determine the unique pallet identification number (pallet-ID). The computing system 110 may then correlate the decoded pallet-ID with a prestored mapping table (e.g., using the SKU database 314) to determine an identity of SKU items (SKU-ID) stored in the pallet. Specifically, the SKU database 314 maintains a mapping of the pallet-IDs to their respective SKU-IDs. Sometimes, other mechanisms may be used to identify the type of SKU items without using the pallet marker. In an embodiment, the SKU-ID can be part of the task data as the computing system 110 stores information about the SKU-IDs. In another embodiment, Optical Character Recognition (OCR) techniques along with Natural Language Processing (NLP) can be used for detection of type of SKU items. In another embodiment, SKU items have barcodes pasted on them and after detecting and decoding the barcodes from the captured images of the pallet, the item identification unit 324 may obtain the SKU-ID information directly. It may be noted that the SKU-ID is associated with a particular type of items stored in the pallet. The SKU-ID may provide information (e.g., in conjunction with the SKU database 314) regarding a particular type of items stored in the pallet, a maximum number of items stored in the pallet, and one or more predefined stacking patterns associated with the items stored in the pallet.

In one non-limiting embodiment, the computing system 110 may correct depth values in the depth images by transforming depth values in the depth images to compensate for distance and inclination with respect to the pallet marker. In an embodiment, in case of raw depth values are not accurate for a specific orientation or position of depth camera of the imaging device 120 then the 3D position estimation unit 322 may correct the depth values using a transformation matrix on the depth image to account for the inclination, position, or both with respect to a plane of the pallet marker.

In one non-limiting embodiment, after performing pre-processing on the selected one or more images, the method 400 may include, at block 410, processing the pre-processed images using a boundary detection model for determining bounding boxes of the one or more visible items present in the pre-processed images while removing partially visible items present in the pre-processed images, removing side surfaces of the one or more visible items, and removing items of neighboring pallets present in the pre-processed images. In an embodiment, the boundary detection model 304 may be continuously trained whenever new data is captured.

Specifically, after identification of the SKU items, the boundary detection unit 320 may leverage the boundary detection model 304 with Faster RCNN object detection framework, yolo framework, or any custom learning model to detect the SKU items. The boundary detection unit 320 highlights visible faces of SKU items detected in input images with bounding box coordinates (or box corners) and counts for such detections, which are filtered later to obtain a count of fully visible front faces. The boundary detection unit 320 may use the depth images to identify item detections missed in RGB images. The boundary detection model 304 may make use of morphology feature in the depth images to detect boundaries of fully visible items. Depth images provide information about the distance of items from a camera, allowing the model to understand the spatial arrangement of the items. Morphology may refer to analysis and processing of shape and structure of items within depth images. The boundary detection unit 320 may select the detections that represent true item faces for visible SKU items and remove invalid item detection. To filter the invalid/false items, the boundary detection unit 320 may identify depth of a patch in a detected bounding box and detect if the identified depth is within a range of the pallet depth (calculated from the pallet marker and pallet dimensions).

In one non-limiting embodiment, the false detection might result from items that have their orientation affected due to removal of neighboring items, due to which the SKU detection provides two faces detected for the same item. The boundary detection unit 320 uses depth data gradient in y-axis direction to calculate standard deviation for every detection. If the value is greater than a predefined threshold, the boundary detection unit 320 may categorize the item as a false face. Sometimes, partial items may be detected when some of the front level items are removed. To detect such bounding boxes as a fully visible item, the boundary detection unit 320 may make use of proportion of length to breadth derived from item corners and check if it matches with expected ratio of actual SKU dimensions fetched from the SKU DB 314.

Next, at block 412 of the method 400, the computing system 110 (specifically, 3D position estimation unit 322) may determine real-world three dimensional (3D) geographical coordinates of each bounding box (of the one or more visible items) by taking the unique identification marker of the pallet as a reference point. To determine the 3D geographical coordinates for the detected true faces of the items, a small patch may be selected towards the top edge midpoint of front face of the item to represent the 3D geographical coordinates of the item. Additionally, the 3D position estimation unit 322 may compute relative position of the detected items in the Y and Z axis from the pallet marker after translating known pixel dimension of the pallet marker to real-world dimensions of the pallet marker. Using the depth images, the 3D position estimation unit 322 may compute mean depth of non-zero points in the selected patch to return relative depth values of the detected boxes from the pallet marker.

At block 414 of the method 400, the computing system 110 may estimate height and depth levels of each of the one or more visible items using the real-world 3D geographical coordinates to generate a 2D top-view stacking pattern of each layer of items present in the specific pallet. Specifically, based on height of the detected items obtained from the 3D geographical coordinates, the item counting unit 326 may group the height of the detected items into ‘n’ height levels using clustering technique where lower most height is set as Level-1 and the remaining are sequentially increased, where ‘n’ indicates the maximum height level of items for the particular SKU item. In an embodiment, distance-based approach may be used to cluster nearby items by height parameter of the 3D geographical coordinates and the item counting unit 326 may generate a list of items grouped according to height. Similar techniques may be applied to estimate the SKU items depth wise and obtain individual depth values from aligning and correlating depth image frames with RGB image frames. By grouping the items height-depth wise, the computing system 110 can determine item count for each level and list of items in a cluster may be plotted against their stacking pattern information obtained from the SKU DB 314 to generate 2D top-view stacking pattern of each layer of items present in the specific pallet.

At block 416 of the method 400, the computing system 110 may determine a count of items present in the specific pallet by correlating the generated 2D top-view stacking patterns of each layer with one or more predefined stacking patterns. For a particular pallet, a specific type of SKU items can be placed on the pallet. A single SKU item might have more than one stacking patterns for different height levels. The item counting unit 326 detects the stacking patterns for every height level in the specific pallet. In an embodiment, an error estimation-based approach may be used to determine the stacking pattern for the ‘n’ levels, where ‘n’ indicates the maximum height level of items for the particular SKU item. To determine the stacking pattern for any level, the item counting unit 326 may plot locations of visible boxes of that level against one or more predefined stacking patterns for the SKU item and an error is calculated for every stacking pattern from the 3D geographical coordinates of the items. For any height level, the stacking pattern of the one or more predefined stacking patterns which gives least error is selected as reference stacking pattern for that level. Said differently, the item counting unit 326 may correlate the generated 2D top-view stacking pattern of each level with the one or more predefined stacking patterns to identify a corresponding reference stacking pattern for that layer. In one non-limiting embodiment, the determined 3D geographical coordinates of the visible items may have some deviation from actual or ideal geographical coordinates (e.g., due to misplacement of items). The item counting unit 326 may correct the determined 3D geographical coordinates of the visible items with respect to the expected real-world position using the reference stacking pattern.

The item counting unit 326 may identify missing items in each layer of the specific pallet (in case of the pallet is not full) by comparing the 3D geographical coordinates corresponding to each visible items of the layer with the corresponding reference stacking pattern of that layer or with the 3D geographical coordinates present in the reference stacking pattern. In an embodiment, partially visible items at back sides may not be detected. To count such type of items, the item counting unit 326 uses the fact that if some adjacent items like front items are visible then the backside items would be present on the pallet (as per Standard Operating Procedures (SOP) of the warehouse). As per warehouse SOPs, items can only be removed from the front side when there are no item on top of a selected item to be removed.

The item counting unit 326 may determine the count of items present in the specific pallet by subtracting a count of missing items of each layer from the maximum number of items that can be stored in the pallet. Specifically, the item counting unit 326 may determine count of boxes for every height level and accordingly calculate aggregate item count for the specific pallet. The total item count for a particular level is determined by subtracting missing item count of that level from the maximum item count for that level determined from the reference stacking pattern, which is same as the sum of the visible items and hidden items of that level. This is repeated for every height level and aggregate count is generated as the number of SKU items for the specific pallet. The aggregate count is sent to the report generation unit 328 to generate meaningful insights as per user's discretion. The reference stacking pattern may be an uniform stacking pattern and a non-uniform stacking pattern, which are based on the strategic placement of items for each level from one or more levels of stacking on the pallet. The strategic placement of items means that the items are intentionally placed in a way to save the space, following a common warehouse organizational guidelines (e.g., the warehouse SOP).

The above-discussed techniques of counting items in a storehouse can be understood using an example. Consider that an exemplary storehouse 100 includes a plurality of racks 140 each comprising at least one pallet 160 for storing one or more items 170. Each pallet may be associated with a unique pallet identification marker 202 and includes a plurality of layers or levels of items arranged in one or more rows and columns. Consider that the user wants to count items stored in a particular pallet (placed in a particular shelf) of the plurality of pallets 160. The user may provide input to the computing system 110 via the user interface 306 for counting items stored in the particular pallet. The input may include at least one of location information and identification information (e.g., pallet identification marker) of the particular pallet. The task scheduling unit 316 may send the task data including the task-ID, the received location information and/or identification information to the imaging device 120. The task data may also include navigation information (or planned path) for navigating to the particular pallet. Upon receiving the task data, the imaging device 120 may initiate from its home position and navigates towards the particular pallet. After reaching neat the particular pallet, the imaging device 120 may position itself taking the pallet identification marker as a reference point until the full FOV of the particular pallet is visible. The imaging device 120 may perform position corrections until the camera of the imaging device 120 is orthogonal to the pallet marker 202 so that orthographic images of the particular pallet are captured.

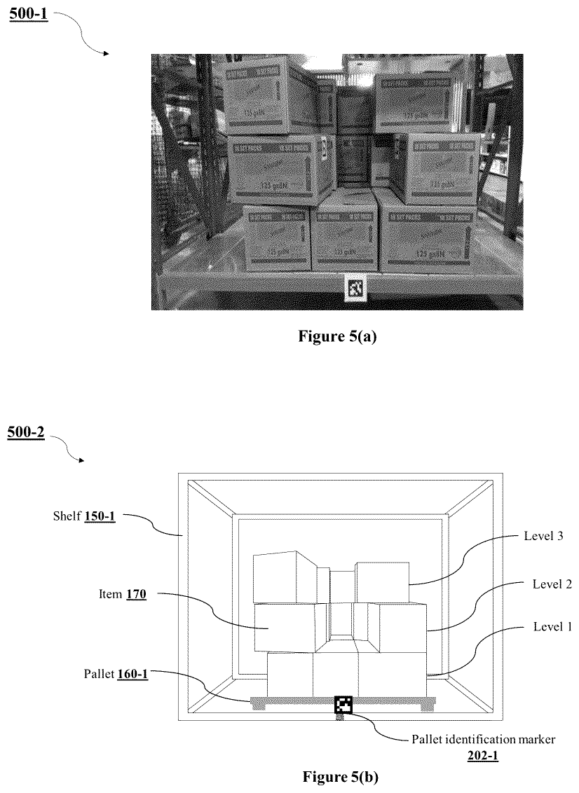

Once the imaging device 120 is properly aligned, it captures a plurality of different types of images (e.g., RGB images, depth images, and the like) of the particular pallet and transmits the captured images to the computing system 120 via the file server 308. Referring to FIG. 5(a), which shows as exemplary camera image 500-1 of a particular shelf 150-1 captured by the imaging device 120. FIG. 5(b) shows an exemplary line image 500-2 corresponding to the camera image 500-1. As shown in FIGS. 5(a) and 5(b), the particular shelf 150-1 includes the particular pallet 160-1 having a plurality of items 170 arranged horizontally and vertically in three layers or height levels (Level 1, Level 2, Level 3) each having three rows and three columns. The captured image 500-1 shows a unique pallet identification marker 202-1 pasted at the midpoint of a pallet beam. The captured image 500-1 along with the pallet identification marker 202-1 is received by the computing device 110. It may be noted that for the sake of explanation, only one pallet image is shown. However, in general, the imaging device 120 captures a plurality of images of the particular pallet 160-1. The images 500-1 and 500-2 may be collectively referred to as captured image 500.

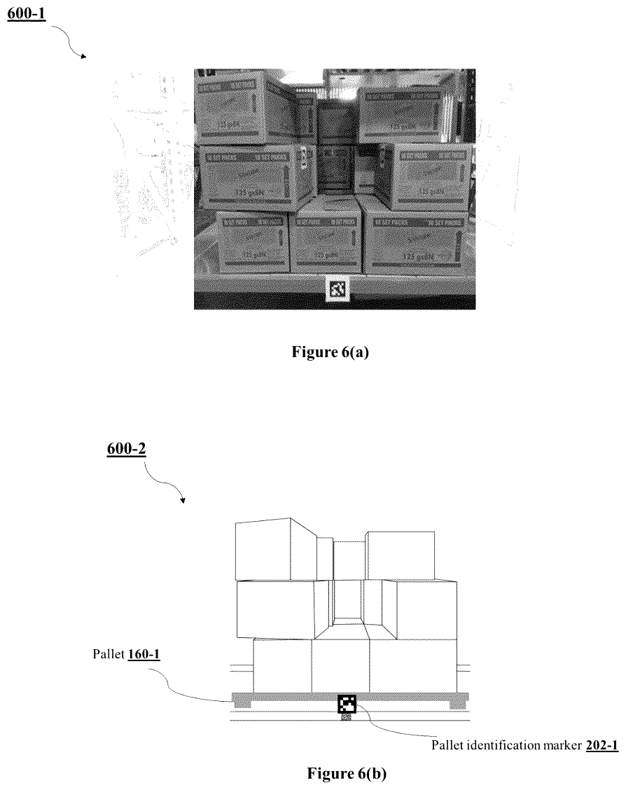

The computing system 110 may then perform image filtering to filter out non-blurred images and select one or more images from the non-blurred images which satisfy one or more criteria. Consider that the captured image 500-1 is a non-blurred image and is satisfying the one or more criteria. Hence, the computing system 110 performs pre-processing on the captures image 500-1 for accurately detecting one or more visible items. Specifically, the computing system 110 masks out the unwanted/unnecessary regions from the image 500-1 and increases the brightness of the image 500-1 with gamma correction, as shown in FIGS. 6(a)-6(b). Referring to FIG. 6(a), which shows as exemplary pre-processed camera image 600-1 of the particular pallet 160-1. FIG. 6(b) shows an exemplary line image 600-2 corresponding to the pre-processed camera image 600-1. It is clear from FIGS. 6(a)-6(b) that the pre-processed image does not comprise unnecessary/unwanted portions and comprises only relevant pallet view. The images 600-1 and 600-2 may be collectively referred to as preprocessed image 600.

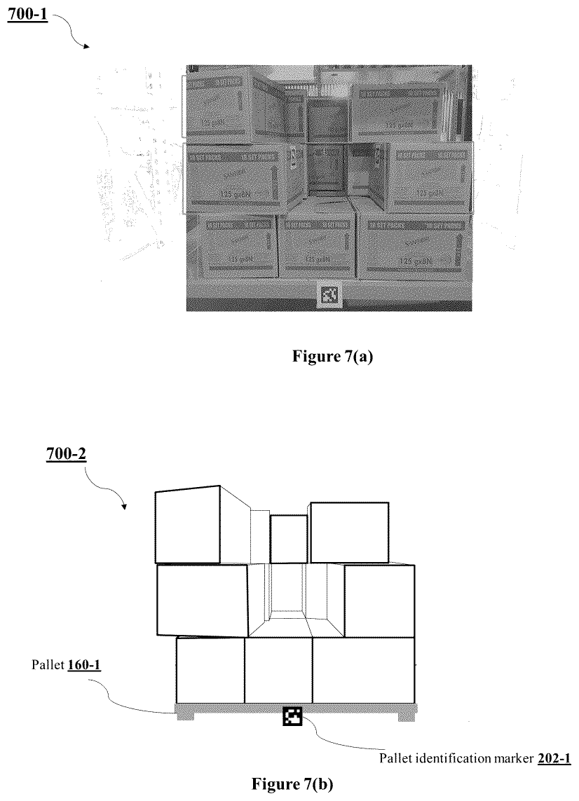

The computing system 110 may then perform processing on the pre-processed image 600 using the boundary detection model 304 for determining bounding boxes of the one or more visible items present in the pre-processed images while removing partially visible items, side surfaces, and neighboring pallets, as shown in FIGS. 7(a)-7(b). Referring to FIG. 7(a), which shows an exemplary processed camera image 700-1 showing bounding boxes of the one or more visible items. FIG. 7(b) shows an exemplary line image 700-2 corresponding to the processed camera image 700-1. It is clear from FIGS. 7(a)-7(b) that the one or more bounding boxes are determined for one or more visible items. The images 700-1 and 700-2 may be collectively referred to as processed image 700.

The computing system 110 may then determine real-world 3D geographical coordinates of each bounding box of the one or more visible items by taking the unique identification marker 202-1 of the particular pallet 160-1 as a reference point. Subsequently, the computing system 110 estimates height and depth levels of each of the one or more visible items using the real-world 3D geographical coordinates and generates a 2D top-view stacking pattern of each layer of items present in the particular pallet 160-1. The computing system 110 may then decode the pallet marker 202-1 to determine SKU-ID of the items stored in the particular pallet 160-1 and may retrieve one or more predefined reference stacking patterns for the determined SKU-ID from the SKU DB 314. Next, the computing system 110 may correlate the generated 2D top-view stacking pattern of each layer with the one or more predefined stacking patterns to identify a corresponding reference stacking pattern for each layer.

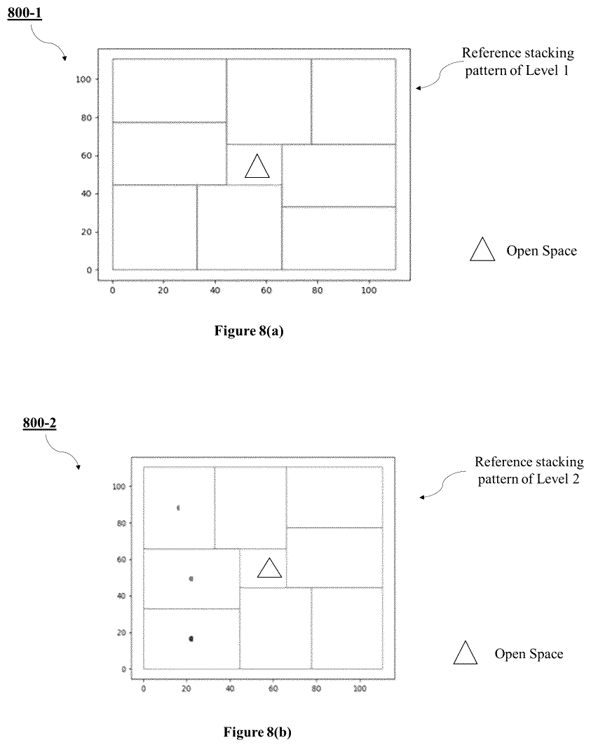

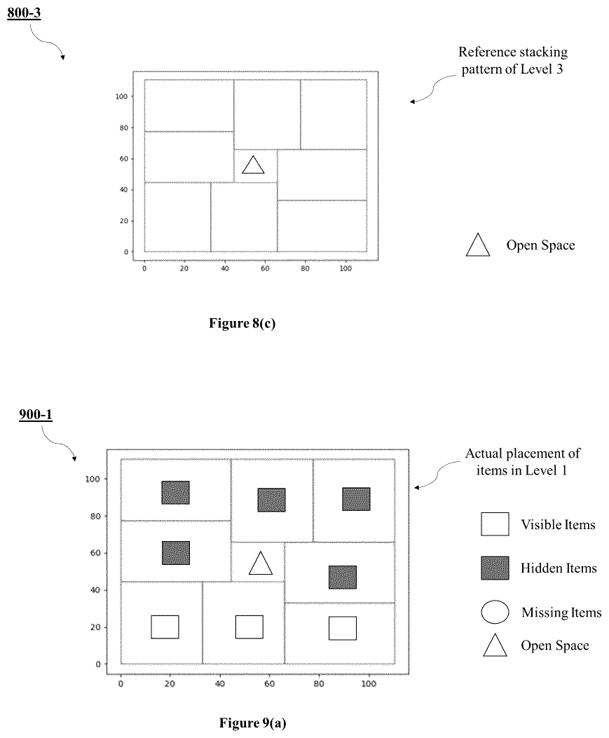

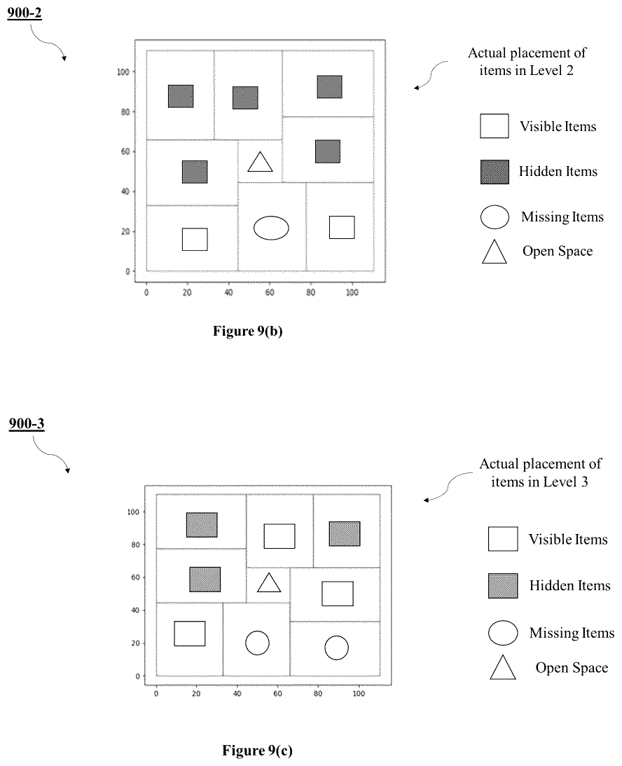

Consider that the reference stacking pattern for Layer 1, Layer 2, and Layer 3 are identified 800-1, 800-2, and 800-3 which are shown in FIGS. 8(a), 8(b), and 8(c), respectively. The computing system 110 may then compare the identified reference stacking patterns with the 3D geographical coordinates or the generated 2D top-views of corresponding layers to find out actual placement of items in each layer. The results of comparison for the three layers Layer 1, Layer 2, and Layer 3 are shown in FIGS. 9(a), 9(b), and 9(c) respectively. The results of comparison 900-1 for Layer 1 shown in FIG. 9(a) indicates that out of a total of eight items in Layer 1, three items are visible, and five items are hidden. The results of comparison 900-2 for Layer 2 shown in FIG. 9(b) indicates that out of a total of eight items in Layer 2, two items are visible, five items are hidden, and one item is missing. Similarly, the results of comparison 900-3 for Layer 3 shown in FIG. 9(c) indicates that out of a total of eight items in Layer 3, three items are visible, three items are hidden, and two items are missing. The total count of items for the particular pallet and item count for each layer may be displayed on the captured image 1000, as shown in FIG. 10. In this manner, the techniques consistent with the present facilitate counting of items in storehouses.

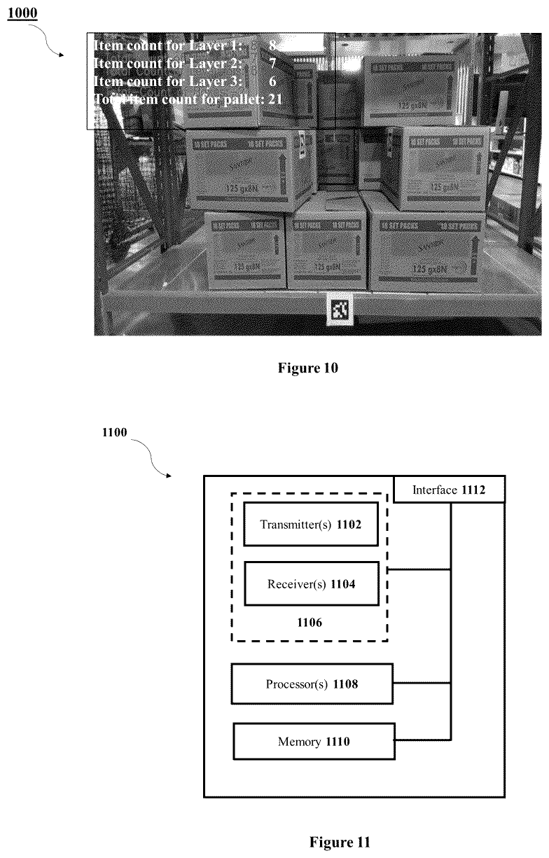

Referring now to FIG. 11 which shows a high-level block diagram of an apparatus 1100 where the techniques consistent with the present disclosure may be implemented, in accordance with some embodiments of the present disclosure. In one non-limiting embodiment, the apparatus 1100 may be used to perform functions of any of: computing system 110, the imaging unit 120, but not limited thereto.

The apparatus 1100 may comprise at least one transmitter 1102, at least one receiver 1104, at least one processor 1108, at least one memory 1110, and at least one interface 1112. The at least one transmitter 1102 may be configured to transmit data/information to one or more units/devices (e.g., using an antenna) and the at least one receiver 1104 may be configured to receive data/information from the one or more units/devices (e.g., using an antenna). The at least one transmitter and receiver may be collectively implemented as a single transceiver module 1106. In one non-limiting embodiment, the at least one processor 1108 may be communicatively coupled with the transceiver 1106, memory 1110, and interface 1112 for implementing the above-described techniques.

The at least one processor 1108 may include, but not restricted to, microprocessors, microcomputers, micro-controllers, central processing units, state machines, logic circuitries, and/or any devices that manipulate signals based on operational instructions. A processor may also be implemented as a combination of computing devices, e.g., a combination of a plurality of microprocessors or any other such configuration. The at least one memory 1110 may be communicatively coupled to the at least one processor 1108 and may comprise various instructions, the SKU database 314, the warehouse KB 302, the boundary detection model 304, and other information related to the warehouse. The at least one memory 1110 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 1108 may be configured to execute one or more instructions stored in the memory 1110.

The interfaces 1112 may include a variety of software and hardware interfaces, for example, a web interface, a graphical user interface, an input device-output device (I/O) interface, a network interface, and the like. The I/O interfaces may allow the apparatus 1100 to communicate with one or more nodes/devices either directly or through other devices. The network interface may allow the apparatus 1100 to interact with one or more networks either directly or via any other network.

The techniques of the present disclosure provide various advantages. For instance, the techniques of the present disclosure enable accurate counting of warehouse items in real-time without requiring any external marker on the items. As a result, the cost and the time of warehouse stocktaking are saved. Moreover, the computing resources needed to generate, affix, and read the external markers are saved. The proposed techniques may autonomously perform the stocktaking without disturbing warehouse operations and work in dim light or low light conditions and even for non-uniform stacking patterns. The proposed techniques can accurately count items even when the rack arrangement is subject to dynamic changes. Further, the proposed techniques provide stocktaking (item counting) with increased accuracy by using standard reference stacking pattern(s).

The above method 400 may be described in the general context of computer executable instructions. Generally, computer executable instructions can include routines, programs, objects, components, data structures, procedures, modules, and functions, which perform specific functions or implement specific abstract data types. The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s) of FIG. 3. Generally, where there are operations illustrated in Figures, those operations may have corresponding counterpart means-plus-function components. It may be noted here that the subject matter of some or all embodiments described with reference to different Figures may be relevant for the method and the same is not repeated for the sake of brevity.

In a non-limiting embodiment of the present disclosure, one or more non-transitory computer-readable media may be utilized for implementing the embodiments consistent with the present disclosure. Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The terms “including”, “comprising”, “having” and variations thereof mean “including but not limited to”, unless expressly specified otherwise. Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the appended claims.

Also disclosed herein are the following clauses:

1. A method for counting items in a storehouse that includes a plurality of racks each including at least one pallet for storing one or more items, wherein each pallet is associated with a unique pallet identification marker and includes a plurality of layers of items arranged in one or more rows and columns, the method comprising:
receiving an input for counting items stored in one or more pallets of the plurality of racks, wherein the input includes at least one of location information and identification information of the one or more pallets;
enabling navigation of a remote imaging device based on the received input for capturing a plurality of images of each of the one or more pallets;
for each of the one or more pallets:
   receiving, from the remote imaging device, a plurality of images of the pallet;
   selecting one or more images from the plurality of images and pre-processing the selected one or more images for accurately detecting one or more visible items present in the pre-processed images of the pallet;
   processing the pre-processed images using a boundary detection model for determining bounding boxes of the one or more visible items present in the pre-processed images while removing partially visible items present in the pre-processed images, removing side surfaces of the one or more visible items, and removing items of neighboring pallets present in the pre-processed images;
   determining real-world three dimensional (3D) geographical coordinates of each bounding box by taking the unique identification marker of the pallet as a reference point;
   estimating height and depth levels of each of the one or more visible items using the real-world 3D geographical coordinates to generate a 2D top-view stacking pattern of each layer of items present in the pallet; and
   determining a count of items present in the pallet by correlating the generated 2D top-view stacking pattern of each layer with one or more predefined stacking patterns.
      2. The method of clause 1, wherein selecting the one or more images includes:
filtering out non-blurred images from the plurality of images based on sharpness of image edges; and
selecting the one or more images from the non-blurred images based on at least one of: determining that each of the one or more images includes the unique identification marker of the pallet;
determining that each of the one or more images includes a full Field of View (FOV) of the pallet; and
determining that each of the one or more images includes non-noisy or readable frames.
   3. The method of any of clauses 1-2, wherein pre-processing the selected one or more images includes:
extracting a region of interest by masking unwanted portions from each of the selected one or more images while taking the unique pallet identification marker as a reference point; and
   performing gamma correction on each of the selected one or more images for enhancing image brightness.
   4. The method of any of clauses 1-3, wherein pre-processing the selected one or more images includes:
processing each of the selected one or more images to decode pallet information present in the pallet identification mark; and
correlating the decoded pallet information with a prestored mapping table to identify a corresponding Stock Keeping Unit identify (SKU-ID) of items stored in the pallet, wherein the SKU-ID provides information regarding a type of items stored in the pallet, a maximum number of items stored in the pallet, and one or more predefined stacking patterns associated with the items stored in the pallet.
   5. The method of clause 4, wherein determining the count of items present in the pallet includes:
identifying a corresponding reference stacking pattern for each layer by correlating the generated 2D top-view stacking pattern of each layer with the one or more predefined stacking patterns;
identifying missing items in each layer by comparing the 3D geographical coordinates corresponding to the one or more visible items with corresponding reference stacking pattern of that layer; and
determining the count of items present in the pallet by subtracting a count of missing items of each layer from the maximum number of items.
   6. The method of any of clauses 1-5, further including:
communicating with the remote imaging device to align a position of the remote imaging device at a fixed distance away from the unique pallet identification marker for capturing full Field of View (FOV) orthographic images of the pallet.
   7. The method of any of clauses 1-6, further including:
updating one or more databases associated with the storehouse, wherein the one or more databases include location information of each rack, dimensions of each rack, location information of each pallet, dimensions of each pallet, identification information of each pallet, a maximum number of items stored in each pallet, a type of items stored in each pallet, predefined stacking patterns associated with each type of items.
   8. An apparatus for counting items in a storehouse that includes a plurality of racks each including at least one pallet for storing one or more items, wherein each pallet is associated with a unique pallet identification marker and includes a plurality of layers of items arranged in one or more rows and columns, the apparatus including:
at least one memory; and
at least one processor communicatively coupled with the memory and configured to:
receive an input for counting items stored in one or more pallets of the plurality of racks, wherein the input includes at least one of location information and identification information of the one or more pallets;
enable navigation of a remote imaging device based on the received input for capturing a plurality of images of each of the one or more pallets;
for each of the one or more pallets:
   receive, from the remote imaging device, a plurality of images of the pallet;
   select one or more images from the plurality of images and pre-processing the selected one or more images for accurately detecting one or more visible items present in the pre-processed images of the pallet;
   process the pre-processed images using a boundary detection model for determining bounding boxes of the one or more visible items present in the pre-processed images while removing partially visible items present in the pre-processed images, removing side surfaces of the one or more visible items, and removing items of neighboring pallets present in the pre-processed images;
   determine real-world three dimensional (3D) geographical coordinates of each bounding box by taking the unique identification marker of the pallet as a reference point;
   estimate height and depth levels of each of the one or more visible items using the real-world 3D geographical coordinates to generate a 2D top-view stacking pattern of each layer of items present in the pallet; and
   determine a count of items present in the pallet by correlating the generated 2D top-view stacking pattern of each layer with one or more predefined stacking patterns.
      9. The apparatus of clause 8, wherein to select the one or more images, the at least one processor is configured to:
filter out non-blurred images from the plurality of images based on sharpness of image edges; and
select the one or more images from the non-blurred images based on at least one of: determining that each of the one or more images includes the unique identification marker of the pallet;
determining that each of the one or more images includes a full Field of View (FOV) of the pallet; and
determining that each of the one or more images includes non-noisy or readable frames.
   10. The apparatus of any of clauses 8-9, wherein to pre-process the selected one or more images, the at least one processor is configured to:
extract a region of interest by masking unwanted portions from each of the selected one or more images while taking the unique pallet identification marker as a reference point; and
   perform gamma correction on each of the selected one or more images for enhancing image brightness.
   11. The apparatus of any of clauses 8-10, wherein to pre-process the selected one or more images, the at least one processor is configured to:
process each of the selected one or more images to decode pallet information present in the pallet identification mark; and
correlate the decoded pallet information with a prestored mapping table to identify a corresponding Stock Keeping Unit identify (SKU-ID) of items stored in the pallet, wherein the SKU-ID provides information regarding a type of items stored in the pallet, a maximum number of items stored in the pallet, and one or more predefined stacking patterns associated with the items stored in the pallet.
   12. The apparatus of clause 11, wherein to determine the count of items present in the pallet, the at least one processor is configured to:
identify a corresponding reference stacking pattern for each layer by correlating the generated 2D top-view stacking pattern of each layer with the one or more predefined stacking patterns;
identify missing items in each layer by comparing the 3D geographical coordinates corresponding to the one or more visible items with corresponding reference stacking pattern of that layer; and
determine the count of items present in the pallet by subtracting a count of missing items of each layer from the maximum number of items.
   13. The apparatus of any of clauses 8-12, wherein the at least one processor is further configured to:
communicate with the remote imaging device to align a position of the remote imaging device at a fixed distance away from the unique pallet identification marker for capturing full Field of View (FOV) orthographic images of the pallet.
   14. The apparatus of any of clauses 8-13, wherein the at least one processor is further configured to:
update one or more databases associated with the storehouse, wherein the one or more databases include location information of each rack, dimensions of each rack, location information of each pallet, dimensions of each pallet, identification information of each pallet, a maximum number of items stored in each pallet, a type of items stored in each pallet, predefined stacking patterns associated with each type of items.
   15. A non-transitory computer readable media for counting items in a storehouse that includes a plurality of racks each including at least one pallet for storing one or more items, wherein each pallet is associated with a unique pallet identification marker and includes a plurality of layers of items arranged in one or more rows and columns, wherein the non-transitory computer readable media stores one or more instructions which, when executed by at least one processor, cause the at least one processor to:
receive an input for counting items stored in one or more pallets of the plurality of racks, wherein the input includes at least one of location information and identification information of the one or more pallets;
enable navigation of a remote imaging device based on the received input for capturing a plurality of images of each of the one or more pallets;
for each of the one or more pallets:
   receive, from the remote imaging device, a plurality of images of the pallet;
   select one or more images from the plurality of images and pre-processing the selected one or more images for accurately detecting one or more visible items present in the pre-processed images of the pallet;
   process the pre-processed images using a boundary detection model for determining bounding boxes of the one or more visible items present in the pre-processed images while removing partially visible items present in the pre-processed images, removing side surfaces of the one or more visible items, and removing items of neighboring pallets present in the pre-processed images;
   determine real-world three dimensional (3D) geographical coordinates of each bounding box by taking the unique identification marker of the pallet as a reference point;
   estimate height and depth levels of each of the one or more visible items using the real-world 3D geographical coordinates to generate a 2D top-view stacking pattern of each layer of items present in the pallet; and
   determine a count of items present in the pallet by correlating the generated 2D top-view stacking pattern of each layer with one or more predefined stacking patterns.
      16. A computer readable media for counting items in a storehouse that includes a plurality of racks each including at least one pallet for storing one or more items, wherein each pallet is associated with a unique pallet identification marker and includes a plurality of layers of items arranged in one or more rows and columns, wherein the computer readable media stores one or more instructions which, when executed by at least one processor, cause the at least one processor to perform the method of any of clauses 1 to 7.

What is claimed is:

1. A method for counting items in a storehouse that includes a plurality of racks each including at least one pallet for storing one or more items, wherein each pallet is associated with a unique pallet identification marker and includes a plurality of layers of items arranged in one or more rows and columns, the method comprising:
receiving an input for counting items stored in one or more pallets of the plurality of racks, wherein the input includes at least one of location information and identification information of the one or more pallets;
enabling navigation of a remote imaging device based on the received input for capturing a plurality of images of each of the one or more pallets;
for each of the one or more pallets:
receiving, from the remote imaging device, a plurality of images of the pallet;
selecting one or more images from the plurality of images and pre-processing the selected one or more images for accurately detecting one or more visible items present in the pre-processed images of the pallet;
processing the pre-processed images using a boundary detection model for determining bounding boxes of the one or more visible items present in the pre-processed images while removing partially visible items present in the pre-processed images, removing side surfaces of the one or more visible items, and removing items of neighboring pallets present in the pre-processed images;
determining real-world three dimensional (3D) geographical coordinates of each bounding box by taking the unique identification marker of the pallet as a reference point;
estimating height and depth levels of each of the one or more visible items using the real-world 3D geographical coordinates to generate a 2D top-view stacking pattern of each layer of items present in the pallet; and
determining a count of items present in the pallet by correlating the generated 2D top-view stacking pattern of each layer with one or more predefined stacking patterns.

2. The method as claimed in claim 1, wherein selecting the one or more images includes:
filtering out non-blurred images from the plurality of images based on sharpness of image edges; and
selecting the one or more images from the non-blurred images based on at least one of:
determining that each of the one or more images includes the unique identification marker of the pallet;
determining that each of the one or more images includes a full Field of View (FOV) of the pallet; and
determining that each of the one or more images includes non-noisy or readable frames.

3. The method as claimed in claim 1, wherein pre-processing the selected one or more images includes:
extracting a region of interest by masking unwanted portions from each of the selected one or more images while taking the unique pallet identification marker as a reference point; and
performing gamma correction on each of the selected one or more images for enhancing image brightness.

4. The method as claimed in claim 1, wherein pre-processing the selected one or more images includes:
processing each of the selected one or more images to decode pallet information present in the pallet identification mark; and
correlating the decoded pallet information with a prestored mapping table to identify a corresponding Stock Keeping Unit identify (SKU-ID) of items stored in the pallet, wherein the SKU-ID provides information regarding a type of items stored in the pallet, a maximum number of items stored in the pallet, and one or more predefined stacking patterns associated with the items stored in the pallet.

5. The method as claimed in claim 4, wherein determining the count of items present in the pallet includes:
identifying a corresponding reference stacking pattern for each layer by correlating the generated 2D top-view stacking pattern of each layer with the one or more predefined stacking patterns;
identifying missing items in each layer by comparing the 3D geographical coordinates corresponding to the one or more visible items with corresponding reference stacking pattern of that layer; and
determining the count of items present in the pallet by subtracting a count of missing items of each layer from the maximum number of items.

6. The method as claimed in claim 1, further including:
communicating with the remote imaging device to align a position of the remote imaging device at a fixed distance away from the unique pallet identification marker for capturing full Field of View (FOV) orthographic images of the pallet.

7. The method as claimed in claim 1, further including:
updating one or more databases associated with the storehouse, wherein the one or more databases include location information of each rack, dimensions of each rack, location information of each pallet, dimensions of each pallet, identification information of each pallet, a maximum number of items stored in each pallet, a type of items stored in each pallet, predefined stacking patterns associated with each type of items.

8. An apparatus for counting items in a storehouse that includes a plurality of racks each including at least one pallet for storing one or more items, wherein each pallet is associated with a unique pallet identification marker and includes a plurality of layers of items arranged in one or more rows and columns, the apparatus including:
at least one memory; and
at least one processor communicatively coupled with the memory and configured to:
receive an input for counting items stored in one or more pallets of the plurality of racks, wherein the input includes at least one of location information and identification information of the one or more pallets;
enable navigation of a remote imaging device based on the received input for capturing a plurality of images of each of the one or more pallets;
for each of the one or more pallets:
receive, from the remote imaging device, a plurality of images of the pallet;
select one or more images from the plurality of images and pre-processing the selected one or more images for accurately detecting one or more visible items present in the pre-processed images of the pallet;
process the pre-processed images using a boundary detection model for determining bounding boxes of the one or more visible items present in the pre-processed images while removing partially visible items present in the pre-processed images, removing side surfaces of the one or more visible items, and removing items of neighboring pallets present in the pre-processed images;
determine real-world three dimensional (3D) geographical coordinates of each bounding box by taking the unique identification marker of the pallet as a reference point;
estimate height and depth levels of each of the one or more visible items using the real-world 3D geographical coordinates to generate a 2D top-view stacking pattern of each layer of items present in the pallet; and
determine a count of items present in the pallet by correlating the generated 2D top-view stacking pattern of each layer with one or more predefined stacking patterns.

9. The apparatus as claimed in claim 8, wherein to select the one or more images, the at least one processor is configured to:
filter out non-blurred images from the plurality of images based on sharpness of image edges; and
select the one or more images from the non-blurred images based on at least one of:
determining that each of the one or more images includes the unique identification marker of the pallet;
determining that each of the one or more images includes a full Field of View (FOV) of the pallet; and
determining that each of the one or more images includes non-noisy or readable frames.

10. The apparatus as claimed in claim 8, wherein to pre-process the selected one or more images, the at least one processor is configured to:
extract a region of interest by masking unwanted portions from each of the selected one or more images while taking the unique pallet identification marker as a reference point; and
perform gamma correction on each of the selected one or more images for enhancing image brightness.

11. The apparatus as claimed in claim 8, wherein to pre-process the selected one or more images, the at least one processor is configured to:
process each of the selected one or more images to decode pallet information present in the pallet identification mark; and
correlate the decoded pallet information with a prestored mapping table to identify a corresponding Stock Keeping Unit identify (SKU-ID) of items stored in the pallet, wherein the SKU-ID provides information regarding a type of items stored in the pallet, a maximum number of items stored in the pallet, and one or more predefined stacking patterns associated with the items stored in the pallet.

12. The apparatus as claimed in claim 11, wherein to determine the count of items present in the pallet, the at least one processor is configured to:
identify a corresponding reference stacking pattern for each layer by correlating the generated 2D top-view stacking pattern of each layer with the one or more predefined stacking patterns;
identify missing items in each layer by comparing the 3D geographical coordinates corresponding to the one or more visible items with corresponding reference stacking pattern of that layer; and
determine the count of items present in the pallet by subtracting a count of missing items of each layer from the maximum number of items.

13. The apparatus as claimed in claim 8, wherein the at least one processor is further configured to:
communicate with the remote imaging device to align a position of the remote imaging device at a fixed distance away from the unique pallet identification marker for capturing full Field of View (FOV) orthographic images of the pallet.

14. The apparatus as claimed in claim 8, wherein the at least one processor is further configured to:
update one or more databases associated with the storehouse, wherein the one or more databases include location information of each rack, dimensions of each rack, location information of each pallet, dimensions of each pallet, identification information of each pallet, a maximum number of items stored in each pallet, a type of items stored in each pallet, predefined stacking patterns associated with each type of items.

15. A computer readable media for counting items in a storehouse that includes a plurality of racks each including at least one pallet for storing one or more items, wherein each pallet is associated with a unique pallet identification marker and includes a plurality of layers of items arranged in one or more rows and columns, wherein the computer readable media stores one or more instructions which, when executed by at least one processor, cause the at least one processor to perform the method as claimed in claim 1.
